(19) United States
(12) Patent Application Publication
(10) Pub. No.: US 2026/0221570 A1
(43) Pub. Date: Jul. 30, 2026

(54) BATTERY ASSEMBLY

(71) Applicant: SK On Co., Ltd., Seoul (KR)

(72) Inventors: Seon Gi MIN, Daejeon (KR); Yun Joo NOH, Daejeon (KR)

(21) Appl. No.: 19/458,928

(22) Filed: Jan. 26, 2026

(30) Foreign Application Priority Data
Jan. 24, 2025 (KR) 10-2025-0010939

(51) Int. Cl. H01M 50/24; H01M 50/178; H01M 50/211; H01M 50/30; H01M 50/502

(52) U.S. Cl. CPC H01M 50/24; H01M 50/178; H01M 50/211; H01M 50/394; H01M 50/502

(57) ABSTRACT

The present disclosure relates to a battery assembly including a plurality of battery cells stacked in a predetermined stacking direction; a receiving case that receives the plurality of battery cells; an insertion space formed between the plurality of battery cells and the receiving case; a first fire-resistant assembly disposed in the insertion space; and a second fire-resistant assembly having a height smaller than a height of the first fire-resistant assembly along a height direction of the receiving case.

### CROSS-REFERENCE TO RELATED PATENT APPLICATION

The present application claims priority under 35 U.S.C. § 119(a) to Korean patent application number 10-2025-0010939 filed on January 24, 2025, in the Korean Intellectual Property Office, the entire disclosure of which is incorporated by reference herein.

### BACKGROUND OF THE INVENTION

### Field

The present disclosure relates to a battery assembly. More specifically, the present disclosure relates to a battery assembly having improved thermal stability.

### Description of the Related Art

Recently, due to fires or explosion accidents occurring during the use of lithium secondary batteries, social concerns regarding the safety of battery use have been increasing. Based on such social concerns, one of the major development tasks of lithium secondary batteries in recent years is to eliminate instability such as fire and explosion caused by thermal runaway of a battery cell.

In particular, in a battery module/pack, there exists an empty space other than the battery cells that serve as the energy source. If a fire occurs due to an external impact or a problem of the battery cell, the flame may be transferred to an adjacent cell through the empty space, thereby increasing the damage caused by the fire. Since such fire hazards may be the greatest obstacle to the electric vehicle market, methods capable of reducing the propagation of fire are being continuously studied.

### SUMMARY OF THE INVENTION

First, according to one aspect of the present disclosure, the problem to be solved is to delay (mitigation) or block thermal propagation (TP) in which high-temperature gas generated from a battery cell in which thermal runaway has occurred among one or more battery cells provided inside a battery assembly, for example, a battery module or a battery pack, is transferred to an adjacent battery cell.

Second, according to another aspect of the present disclosure, the problem to be solved is to vent high-temperature gas generated from a battery cell in which thermal runaway has occurred along an intended path.

Third, according to still another aspect of the present disclosure, the problem to be solved is to increase heat resistance or fire resistance and thereby enhance thermal stability of the battery assembly.

Meanwhile, the battery assembly of the present disclosure can be widely applied in green technology fields such as electric vehicles, battery charging stations, and solar power generation and wind power generation using batteries. In addition, the battery assembly of the present disclosure can be used in eco-friendly electric vehicles and hybrid vehicles for preventing climate change by suppressing air pollution and greenhouse gas emissions.

As a technical means to achieve the technical objects, a battery assembly according to the present disclosure may include a plurality of battery cells stacked in a predetermined stacking direction; a receiving case that receives the plurality of battery cells; an insertion space formed between the plurality of battery cells and the receiving case; a first fire-resistant assembly disposed in the insertion space; and a second fire-resistant assembly having a height smaller than a height of the first fire-resistant assembly along a height direction of the receiving case.

In one embodiment, the first fire-resistant assembly and the second fire-resistant assembly may be arranged along the stacking direction.

In one embodiment, the battery assembly according to the present disclosure may further include a heat blocking member disposed between the plurality of battery cells along the stacking direction.

In one embodiment, the plurality of battery cells may include a plurality of battery groups in which battery cells adjacent to each other are grouped by a predetermined number, and the heat blocking member may be disposed between the plurality of battery groups.

In one embodiment, the insertion space may be partitioned by the heat blocking member.

In one embodiment, the insertion spaces partitioned by the heat blocking member may respectively receive the first fire-resistant assembly and the second fire-resistant assembly.

In one embodiment, the battery assembly according to the present disclosure may further include a through-hole that is formed by penetrating one surface of the receiving case along the stacking direction and overlaps the insertion space.

In one embodiment, the plurality of battery cells may include a plurality of battery groups in which battery cells adjacent to each other are grouped by a predetermined number, and the through-hole may be provided as a plurality of through-holes, and the plurality of through-holes may be disposed to overlap the plurality of battery groups.

In one embodiment, the battery assembly according to the present disclosure may further include a heat blocking member disposed between the plurality of battery groups along the stacking direction.

In one embodiment, the first fire-resistant assembly and the second fire-resistant assembly may be respectively provided as a plurality, and at least some of the plurality of second fire-resistant assemblies may be disposed to overlap the plurality of through-holes.

In one embodiment, the first fire-resistant assembly and the second fire-resistant assembly may respectively include a fire-resistant member that includes a fire-resistant material; and an outer member that forms a fire-resistant space receiving the fire-resistant member therein, and a height of the outer member of the first fire-resistant assembly may be greater than a height of the outer member of the second fire-resistant assembly.

In one embodiment, each of the plurality of battery cells may include a body portion that receives an electrode assembly therein; and a lead tab portion that is electrically connected to the electrode assembly and protrudes from the body portion, and the insertion space may be partitioned into a plurality of separated spaces by the respective lead tab portions of the plurality of battery cells.

In one embodiment, the first fire-resistant assembly may be received in any one of the plurality of separated spaces, and the second fire-resistant assembly may be received in another one of the plurality of separated spaces.

In one embodiment, the insertion space may include a first insertion space and a second insertion space that are formed with the plurality of battery cells therebetween, and the first fire-resistant assembly and the second fire-resistant assembly may be disposed in at least any one of the first insertion space and the second insertion space.

Meanwhile, the battery assembly according to the present disclosure may include a plurality of battery cells stacked in a predetermined stacking direction; a receiving case that receives the plurality of battery cells; a busbar that is electrically connected to the plurality of battery cells inside the receiving case; an insertion space formed between the plurality of battery cells and the busbar; a first fire-resistant assembly disposed in the insertion space; and a second fire-resistant assembly having a height smaller than a height of the first fire-resistant assembly along a height direction of the receiving case.

First, according to one embodiment of the present disclosure, thermal propagation (TP), in which high-temperature gas generated from a battery cell in which thermal runaway occurs among one or more battery cells provided inside a battery assembly, for example, a battery module or a battery pack, is transferred to an adjacent battery cell, can be delayed (mitigation) or blocked.

Second, according to another embodiment of the present disclosure, high-temperature gas generated from a battery cell in which thermal runaway occurs can be vented along an intended path.

Third, according to still another embodiment of the present disclosure, heat resistance or fire resistance can be increased to improve thermal stability of the battery assembly.

### BRIEF DESCRIPTION OF THE DRAWINGS

FIG. 1 is an example of a battery assembly according to the present disclosure.

FIG. 2 is an exploded example of a battery assembly according to the present disclosure.

FIG. 3 is a top view of a battery assembly according to the present disclosure.

FIG. 4 is a side view of a battery assembly according to the present disclosure.

FIG. 5 is an enlarged view of S1 of FIG. 4.

### DETAILED DESCRIPTION

Hereinafter, the present disclosure will be described in detail with reference to the accompanying drawings. However, this is merely exemplary, and the present disclosure is not limited to the specific embodiments described as examples.

The battery, secondary battery, or cell used in the present disclosure means a rechargeable battery cell.

In addition, the battery assembly 200, 300 according to the present disclosure is a concept collectively referring to a battery module, a battery pack, or an energy storage system (ESS). Therefore, the battery assembly 200, 300 according to the present disclosure may mean not only a battery module but also a battery pack or an energy storage system (ESS) that receives battery cells without a battery assembly, such as Cell to Pack (CTP).

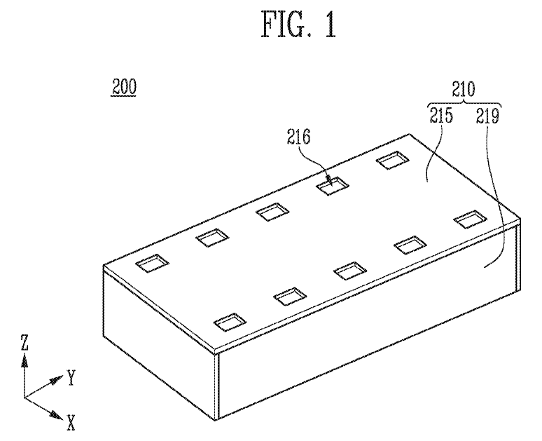

FIG. 1 is an example of a battery assembly according to the present disclosure.

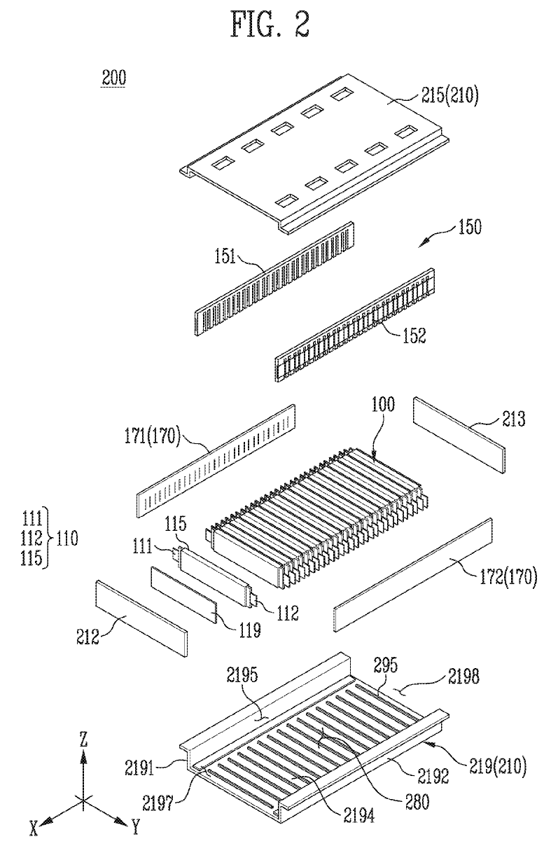

The battery assembly 200 according to the present disclosure may include a receiving case 210 that receives a plurality of battery cells 110 (see FIG. 2).

The receiving case 210 may include a receiving body 219 and a receiving cover 215. The receiving body 219 and the receiving cover 215 together may form a receiving space 280 (see FIG. 2) that receives the plurality of battery cells 110.

The receiving case 210 may include a through-hole 216 that penetrates one surface of the receiving case 210. More specifically, the through-hole 216 may be formed in the receiving cover 215.

The through-hole 216 is for rapidly discharging gas generated when thermal runaway occurs in the plurality of battery cells. Since the gas has a property of moving upward due to temperature, the through-hole 216 may be formed on an upper surface of the receiving cover 215 or the receiving case 210.

FIG. 2 is an exploded example of a battery assembly according to the present disclosure.

Referring to FIG. 2, the battery assembly 200 according to the present disclosure may include a plurality of battery cells 110 arranged along a predetermined stacking direction, and a receiving case 210 that receives the plurality of battery cells 110.

Each of the plurality of battery cells 110 may include a body portion 115 that generates or stores electrical energy, and lead tab portions 111 and 112 that protrude from the body portion 115 to the outside of the body portion 115. The body portion 115 may include an electrode assembly (not shown) including a positive electrode and a negative electrode therein for the generation and storage of electrical energy.

In addition, the body portion 115 further includes an electrolyte (not shown) that contacts the electrode assembly. The electrolyte may be liquid or solid. In addition, when the electrolyte is liquid, the electrode assembly may further include a separator for separating the positive electrode and the negative electrode. Referring to FIG. 2, the body portion 115 may be in a pouch form sealed with an exterior member in the form of a film.

FIG. 2 illustrates an example of the battery cell 110 in a pouch form, but this is not limited thereto. Therefore, it is applicable to prismatic and cylindrical battery cells.

Specifically, the lead tab portions 111 and 112 may include a first lead tab portion 111 and a second lead tab portion 112 that protrude from both side surfaces of the body portion 115 in a direction away from the body portion 115. Alternatively, the lead tab portions 111 and 112 may be provided to protrude in the same direction.

The receiving case 210 is for protecting the plurality of battery cells 110 from external impacts such as vibration. The receiving case 210 may include a receiving body 219 that forms a portion of a receiving space 280 that receives the plurality of battery cells 110 to be described below.

The receiving case 210 may include a receiving body 219 that forms a portion of the receiving space 280 that receives the cell stack 100, and a receiving cover 215 that is coupled to the receiving body 219 to together form the receiving space 280.

Inside the receiving body 219, the plurality of battery cells 110 may be located in an overlapped manner along a predetermined stacking direction (e.g., the X direction).

More specifically, the receiving case 210 may include an opened upper surface 2195, and may further include the receiving body 219 that receives the plurality of battery cells 110 through the opened upper surface 2195, and the receiving cover 215 that is coupled to the receiving body 219 and closes the opened upper surface 2195.

Accordingly, the receiving cover 215 may be coupled to the receiving body 219 to form an upper surface of the receiving space 280 or an upper surface of the receiving case 210. That is, the receiving cover 215 is coupled to the receiving body 219 to close the opened upper surface 2195, and together with the receiving body 219 will form the receiving space 280.

The receiving space 280 may not only receive the cell stack 100, but a portion of the receiving space 280 may also form an insertion space 288 to be described later.

Meanwhile, the receiving body 219 may be provided in a channel shape or a U-shape having an opened upper portion. Referring to FIG. 2, both side surfaces 2197 and 2198, which face each other along the X direction among the side surfaces of the receiving body 219, may also be opened.

That is, the receiving body 219 may include a body bottom surface 2194 that forms a bottom surface of the receiving space 280, and body side surfaces 2191 and 2192 that extend toward the receiving cover 215 from edges (not shown) of the body bottom surface 2194 that are arranged along the stacking direction. A free end of each of the body side surfaces 2191 and 2192 may be bent to form a flange (not shown). This is for facilitating coupling with the receiving cover 215.

A height of the receiving body 219 may be smaller than a height of the plurality of battery cells 110. However, this is merely an example, and the height of the receiving body 219 may be equal to or greater than the height of the plurality of battery cells 110. For reference, the height direction of the receiving case 210 may be a direction (e.g., the Z direction) from the receiving body 219 toward the receiving cover 215.

For example, referring to FIG. 2, the stacking direction of the plurality of battery cells 110 may be the X direction, the height direction of the receiving case 210 or the receiving body 219 may be the Z direction, and the protruding direction in which the lead tab portions 111 and 112 protrude may be the Y direction. However, this is merely an example, and the directions are not limited thereto. That is, the height direction and the protruding direction, or the stacking direction and the height direction, may be the same. In addition, although FIG. 2 illustrates the stacking direction, the height direction, and the protruding direction as being perpendicular to each other, this is merely an example, and they may not be perpendicular to each other.

As described above, the receiving cover 215 may include the through-hole 216 that penetrates the receiving cover 215.

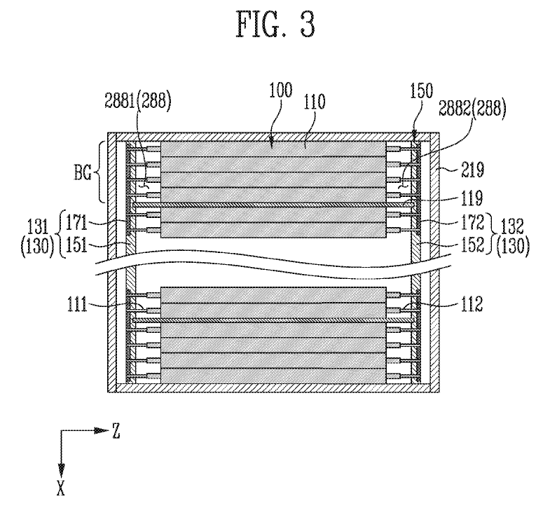

Meanwhile, the cell stack 100 may further include a heat blocking member 119 (see FIG. 3) located between the plurality of battery cells 110. The heat blocking member 119 may be located between the plurality of battery cells 110. More specifically, it may be located between battery groups BG (see FIG. 3) in which the plurality of battery cells 110 are grouped by a predetermined number.

The heat blocking member 119 may perform a role of a thermal barrier for preventing flame or heat from being propagated from a battery cell 110 in which thermal runaway occurs to another adjacent battery cell 110. To this end, the heat blocking member 119 may be formed of a fire-resistant (heat-resistant or flame-retardant) material. For example, the heat blocking member 119 may include a fire-resistant polymer or a material such as mica.

The heat blocking member 119 may also perform a role of a buffer member that applies a predetermined pressure to the plurality of battery cells 110 in order to prevent swelling during charging and discharging of the plurality of battery cells 110.

Meanwhile, the battery assembly 200 may further include end plates 212 and 213 at both ends of the cell stack 100 along the stacking direction. The end plates 212 and 213 may be provided at both ends of the cell stack 100 and may be connected to both side surfaces 2197 and 2198 of the receiving body 219. The end plates 212 and 213 are for preventing both side surfaces of the cell stack 100 from being exposed to the outside.

Accordingly, the end plates 212 and 213 may be disposed at outermost locations of the plurality of battery cells 110 along the direction (X direction) in which the plurality of battery cells are stacked.

The battery assembly 200 according to the present disclosure may further include a busbar 170 that electrically connects the plurality of battery cells 110. In addition, the battery assembly 200 according to the present disclosure may further include a busbar frame 150 that supports the busbar 170 and the plurality of battery cells 110 that are electrically connected to the busbar 170. The busbar 170 and the busbar frame 150 together may be referred to as a busbar assembly 130 (see FIG. 3).

That is, the busbar assembly 130 may include the busbar 170 that is electrically connected to the plurality of battery cells 110, and the busbar frame 150 that is located between the busbar 170 and the plurality of battery cells 110 and supports the busbar 170, and into which the respective lead tab portions 111 and 112 of the plurality of battery cells 110 are inserted.

The busbar assembly 130 or the busbar 170 assembled with the plurality of battery cells 110 may be referred to as the cell stack 100.

The busbar assembly 130 may include a first busbar frame 151 and a second busbar frame 152 that extend along the stacking direction of the plurality of battery cells 110 with the plurality of battery cells 110 interposed therebetween.

The busbar assembly 130 is described in a case where the lead tab portions 111 and 112 are located in opposite directions of the body portion 115. Alternatively, when the lead tab portions 111 and 112 are located on one side of the body portion 115 and face the same direction, the busbar frames 151 and 152 may be located on one side (for example, an upper portion) of the body portion 115 and may be electrically connected to the lead tab portions 111 and 112.

The busbar 170 may include a first busbar 171 that is supported by the first busbar frame 151 and electrically connected to the first lead tab portion 111, and a second busbar 172 that is supported by the second busbar frame 152 and electrically connected to the second lead tab portion 112.

The first busbar 171 and the second busbar 172 may be located in a direction away from the plurality of battery cells 110 relative to the first busbar frame 151 and the second busbar frame 152, respectively.

That is, the first busbar 171 may be located between the plurality of battery cells 110 and the first busbar frame 151, and the second busbar 172 may be located between the plurality of battery cells 110 and the second busbar frame 152.

The first busbar 171 may contact an outer side of the first busbar frame 151, and the second busbar 172 may contact an outer side of the second busbar frame 152. That is, the first busbar 171 and the second busbar 172 may each be located closer to the body side surfaces 2191 and 2192 than the first busbar frame 151 and the second busbar frame 152, respectively. Accordingly, the first lead tab portion 111 and the second lead tab portion 112 may be inserted into slit holes (not shown) formed in the first busbar frame 151 and the second busbar frame 152, respectively, and may be electrically connected to the first busbar 171 and the second busbar 172. However, this is merely an example, and the first lead tab portion 111 and the second lead tab portion 112 may be electrically connected to the first busbar 171 and the second busbar 172 in another manner.

Meanwhile, the battery assembly 200 may further include a heat dissipation portion 295 that is located between the body bottom surface 2194 and the plurality of battery cells 110 and transfers heat generated from the plurality of battery cells 110 to an outside of the battery assembly 200.

The heat dissipation portion 295 may be provided as an adhesive material having thermal conductivity, for example, a heat-dissipating adhesive. Accordingly, the plurality of battery cells 110 may be adhered to the body bottom surface 2194 through the heat dissipation portion 295. To this end, the heat dissipation portion 295 may be sprayed or applied on the body bottom surface 2194.

FIG. 3 is a top view of a battery assembly according to the present disclosure.

The busbar assembly 130 may include a first busbar 171 that is electrically connected to the first lead tab portion 111, and a first busbar frame 151 that supports the first busbar 171. The first busbar 171 and the first busbar frame 151 together may be referred to as a first busbar assembly 131. That is, the first busbar assembly 131 may be electrically connected to the first lead tab portion 111 and may perform a role of supporting the cell stack 100.

The busbar assembly 130 may further include a second busbar 172 that is electrically connected to the second lead tab portion 112, and a second busbar frame 152 that supports the second busbar 172. The second busbar 172 and the second busbar frame 152 together may be referred to as a second busbar assembly 132. That is, the second busbar assembly 132 may be electrically connected to the second lead tab portion 112 and may perform a role of supporting the cell stack 100 together with the first busbar assembly 131.

Referring to FIG. 3, due to the electrical connection between the lead tab portions 111 and 112 and the busbar assembly 130, an empty space (hereinafter referred to as the insertion space 288) may be formed between the plurality of battery cells 110 and the busbar assembly 130.

That is, a portion of the receiving space 280 formed inside the receiving case 210 is a space that receives the plurality of battery cells 110, and another portion of the receiving space 280 may be a space for the insertion space 288.

That is, the insertion space 288 may be formed between the plurality of battery cells 110 and the receiving case 210. More specifically, the insertion space 288 is a space formed by each body portion 115 of the plurality of battery cells 110, each lead tab portion 111 and 112 of the plurality of battery cells 110, and the busbar 170. In a typical case, when gas (or off-gas) is generated due to thermal runaway of any one of the plurality of battery cells 110, high-temperature heat may be propagated to an adjacent battery cell through the insertion space 288. To prevent such thermal propagation (TP), the insertion space 288 needs to be filled with another fire-resistant (flame-retardant or heat-resistant) material.

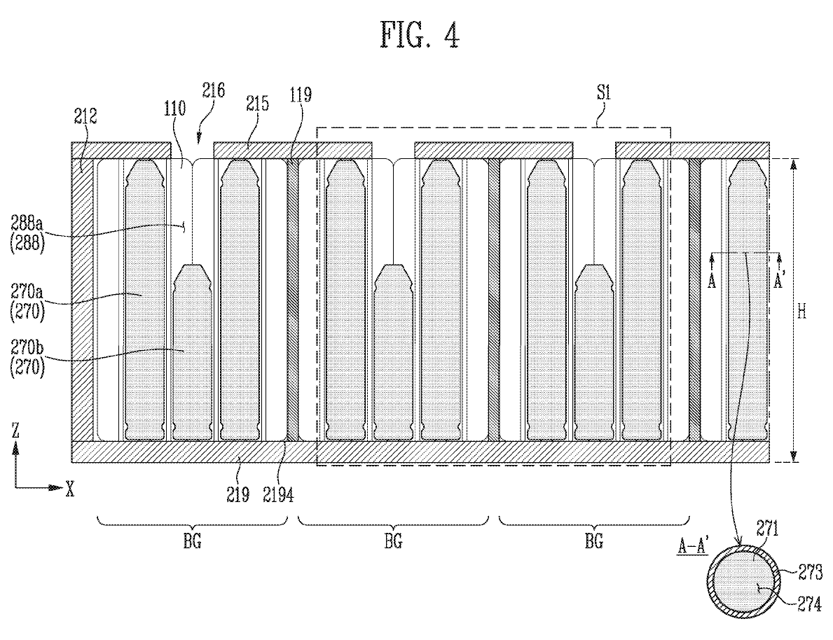

To this end, the battery assembly 200 according to the present disclosure may include a fire-resistant assembly 270 (see FIG. 4) that is inserted into and located in the insertion space 288.

That is, the battery assembly 200 according to the present disclosure may include a plurality of battery cells 110 stacked in a predetermined stacking direction, a receiving case 210 that receives the plurality of battery cells 110, an insertion space 288 formed between the plurality of battery cells 110 and the receiving case 210, and a fire-resistant assembly 270 that is disposed in the insertion space 288 and includes a fire-resistant member 271 including a fire-resistant material and an outer member 273 that forms a fire-resistant space 274 receiving the fire-resistant member 271 therein.

Meanwhile, referring to FIG. 3, the heat blocking member 119 may be located between the plurality of battery cells 110. The heat blocking member 119 may be provided between each of the plurality of battery cells 110. Alternatively, the heat blocking member 119 may be located between battery groups BG in which adjacent battery cells 110 are grouped by a predetermined number.

The battery group BG refers to a set of battery cells 110 in which adjacent battery cells 110 among the plurality of battery cells 110 are grouped by a predetermined number (or a preset group number). The plurality of battery cells 110 may be grouped by the group number for a predetermined target voltage or target current, and then the battery groups BG may be connected in series or in parallel using the busbar 170.

Meanwhile, the length of the heat blocking member 119 along a direction from the first busbar frame 151 toward the second busbar frame 152 may be greater than a length of the body portion 115. More specifically, the heat blocking member 119 may contact the first busbar assembly 131 and the second busbar assembly 132. Through this, the heat blocking member 119 may block or delay heat or flame from being propagated elsewhere when thermal runaway occurs in any of the battery cells 110.

The insertion space 288 includes a first insertion space 2881 formed between the plurality of battery cells 110 and one side surface of the receiving case 210 extending along the stacking direction, and a second insertion space 2882 formed between the plurality of battery cells 110 and the other side surface of the receiving case 210 facing the one side surface, and the fire-resistant assembly 270 may be disposed in at least any one of the first insertion space 2881 and the second insertion space 2882.

Meanwhile, the first insertion space 2881 may be separated by the first lead tab portion 111. In addition, the second insertion space 2882 may be separated by the second lead tab portion 112. However, when the cell stack 100 is received in the receiving body 219, lengths of the first lead tab portion 111 and the second lead tab portion 112 along the height direction of the receiving case 210 or the receiving body 219 are smaller than a height of the battery cell 110, and thus the first insertion space 2881 and the second insertion space 2882 may each be in communication with each other.

In addition, the first insertion space 2881 and the second insertion space 2882 may be in communication with each other through a space between the plurality of battery cells 110 and the receiving cover 215. Therefore, the first insertion space 2881 and the second insertion

space 2882 may not be separated and isolated spaces, but may be spaces capable of communicating with each other.

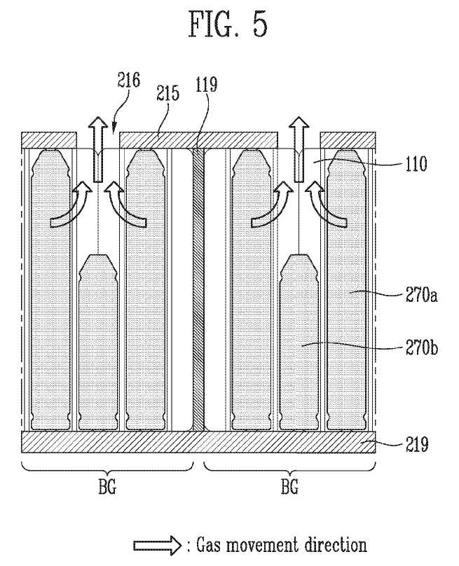

In the present disclosure, unless explicitly stated otherwise, the description of the insertion space 288 may be applied to the first insertion space 2881 and the second insertion space 2882. Therefore, in FIG. 4 and FIG. 5, the term “insertion space 288” may refer to at least any one of the first insertion space 2881 and the second insertion space 2882 unless explicitly stated otherwise.

FIG. 4 is a side view of a battery assembly according to the present disclosure.

The battery assembly 200 according to the present disclosure may include the fire-resistant assembly 270 in the insertion space 288.

And the fire-resistant assembly 270 may include a first fire-resistant assembly 270a and a second fire-resistant assembly 270b having different heights.

If the first fire-resistant assembly 270aand the second fire-resistant assembly 270bare formed at the same height, all passages through which gas generated during thermal runaway is discharged may be blocked. Therefore, the battery assembly 200 according to the present disclosure is to rapidly discharge the gas by using the empty space generated due to the relatively low height of the second fire-resistant assembly 270b. To this end, a position of the second fire-resistant assembly 270b and a position of the through-hole 216 may overlap each other.

That is, the battery assembly 200 according to the present disclosure may include a plurality of battery cells 110 stacked in a predetermined stacking direction, a receiving case 210 that receives the plurality of battery cells 110, an insertion space 288 formed between the plurality of battery cells 110 and the receiving case 210, a first fire-resistant assembly 270a disposed in the insertion space 288, and a second fire-resistant assembly 270b having a height smaller than a height of the first fire-resistant assembly 270a along a height direction of the receiving case 210.

Or, the battery assembly 200 according to the present disclosure may include a plurality of battery cells 110 stacked in a predetermined stacking direction, a receiving case 210 that receives the plurality of battery cells 110, a busbar 170 that is electrically connected to the plurality of battery cells 110 inside the receiving case 210, an insertion space 288 formed between the plurality of battery cells 110 and the busbar 170, a first fire-resistant assembly 270adisposed in the insertion space 288, and a second fire-resistant assembly 270b having a height smaller than a height of the first fire-resistant assembly 270a along the height direction of the receiving case 210.

The first fire-resistant assembly 270aand the second fire-resistant assembly 270b may be arranged along the stacking direction. That is, the first fire-resistant assembly 270a and the second fire-resistant assembly 270b may be arranged in a line along the stacking direction.

As described above, the battery assembly 200 according to the present disclosure may further include a heat blocking member 119 disposed between the plurality of battery cells 110 along the stacking direction.

More specifically, the plurality of battery cells 110 may include a plurality of battery groups BG in which adjacent battery cells 110 are grouped by a predetermined number, and the heat blocking member 119 may be disposed between the plurality of battery groups BG.

Referring to FIG. 3 and FIG. 4, the insertion space 288 may be partitioned by the heat blocking member 119. Accordingly, the insertion spaces 288 partitioned by the heat blocking member 119 may respectively receive the first fire-resistant assembly 270a and the second fire-resistant assembly 270b.

Meanwhile, the battery assembly 200 according to the present disclosure may further include a through-hole 216 that is formed by penetrating one surface of the receiving case 210 along the stacking direction and overlaps the insertion space 288.

More specifically, the through-hole 216 may be formed in the receiving cover 215.

Referring to FIG. 1 and FIG. 4, a plurality of the through-holes 216 may be provided, and the plurality of through-holes 216 may be arranged along the stacking direction.

In addition, for rapid gas discharge during thermal runaway, the plurality of through-holes 216 may be disposed to overlap the plurality of battery groups BG.

That is, the plurality of battery cells 110 may include a plurality of battery groups BG in which adjacent battery cells 110 are grouped by a predetermined number, and the plurality of through-holes 216 may be provided, and the plurality of through-holes 216 may be disposed to overlap the plurality of battery groups BG.

Referring to FIG. 4, the first fire-resistant assembly 270aand the second fire-resistant assembly 270bmay each be provided as a plurality, and at least some of the plurality of second fire-resistant assemblies 270b may be disposed to overlap the plurality of through-holes 216.

Alternatively, the heat blocking member 119 may be disposed so as not to overlap the through-hole 216. The heat blocking member 119 is for preventing thermal runaway occurring in any one battery group BG from being propagated to another adjacent battery group BG.

The through-hole 216 may be disposed to overlap the second fire-resistant assembly 270b. That is, the through-hole 216 may be disposed above the second fire-resistant assembly 270b, so that gas generated during thermal runaway is rapidly discharged through a space between the receiving case 210 and the second fire-resistant assembly 270bor a space between the receiving cover 215 and the second fire-resistant assembly 270b.

Referring to FIG. 3 and FIG. 4, the insertion space 288 may be partitioned into a plurality of separated spaces 288a by the respective lead tab portions 111 and 112 of the plurality of battery cells 110.

More specifically, the plurality of separated spaces 288a may each be formed by the busbar frame 150, each body portion 115, and each lead tab portion 111 and 112.

That is, each of the lead tab portions 111 and 112 includes the first lead tab portion 111 that partitions the first insertion space 2881 and the second lead tab portion 112 that partitions the second insertion space 2882, and the first insertion space 2881 and the second insertion space 2882 may each be partitioned into the plurality of separated spaces 288a by the first lead tab portion 111 and the second lead tab portion 112, respectively.

The respective lead tab portions 111 and 112 do not completely isolate the plurality of separated spaces 288a. That is, since lengths of the respective lead tab portions 111 and 112 along the height direction of the receiving case 210 are smaller than a height of the receiving space 280, they divide only a portion along the height of the receiving space 280.

That is, since lengths of the respective lead tab portions 111 and 112 along the height direction of the receiving case 210 are smaller than lengths of the respective body portions 115, the plurality of separated spaces 288a may be separated or may communicate with each other by the respective lead tab portions 111 and 112.

Accordingly, as described above, the plurality of separated spaces 288a may be capable of communicating with each other.

Each of the plurality of battery cells 110 includes a body portion 115 that receives an electrode assembly (not shown) therein, and a lead tab portion 111 and 112 that is electrically connected to the electrode assembly and partially protrudes from the body portion 115, and the insertion space 288 may be partitioned into the plurality of separated spaces 288a by the respective lead tab portions 111 and 112 of the plurality of battery cells 110.

Accordingly, the first fire-resistant assembly 270a may be received in any one of the plurality of separated spaces 288a, and the second fire-resistant assembly 270b may be received in another one of the plurality of separated spaces 288a.

In addition, the insertion space 288 includes the first insertion space 2881 and the second insertion space 2882 that are formed with the plurality of battery cells 110 therebetween, and the first fire-resistant assembly 270a and the second fire-resistant assembly 270b may be disposed in at least any one of the first insertion space 2881 and the second insertion space 2882.

Meanwhile, the first fire-resistant assembly 270a and the second fire-resistant assembly 270beach include a fire-resistant member 271 that includes a fire-resistant material, and an outer member that forms a fire-resistant space 274 that receives the fire-resistant member 271 therein, and a height of the outer member of the first fire-resistant assembly 270a may be greater than a height of the outer member of the second fire-resistant assembly 270b.

The fire-resistant member 271 may be in a form of fire-resistant particles. That is, the fire-resistant member 271 may be a solid filler. And the form of the solid filler may be a plurality of granular material (granular or pellet-like).

One or more of two end portions 276 and 277 of the fire-resistant assembly 270 or the outer member 273 may be tapered.

This is to facilitate insertion of the fire-resistant assembly 270 into the insertion space 288. That is, one or more of two end portions 276 and 277 of the fire-resistant assembly 270 may be formed in a tapered shape so that the fire-resistant assembly 270 is guided into the insertion space 288 when the fire-resistant assembly 270 is inserted into the insertion space 288.

Meanwhile, the outer member 273 includes a polymer that melts when a predetermined temperature is reached, and the fire-resistant member 271 may not melt or burn at a temperature equal to or higher than the predetermined temperature, unlike the outer member 273. Specifically, the polymer may be any one of polyethylene (PE) or polypropylene (PP), or a combination thereof. Accordingly, the fire-resistant assembly 270 may be referred to as a fire-retardant capsule or an FR capsule.

FIG. 4 illustrates an example in which the battery group BG includes three battery cells 110, and the number of the battery group BG may vary depending on design. Therefore, the number of the first fire-resistant assemblies 270a and the second fire-resistant assemblies 270b that are disposed to correspond to the battery groups BG may vary depending on the number of battery cells 110 included in the battery group BG.

FIG. 5 is an enlarged view of S1 of FIG. 4.

Referring to FIG. 5, the through-hole 216 may be formed by penetrating the receiving cover 215. Although FIG. 5 illustrates an example in which the through-hole 216 is formed in the receiving cover 215, the through-hole 216 may also be formed on an upper portion of a side surface of the receiving body 219.

Meanwhile, the second fire-resistant assembly 270b may be disposed vertically below the through-hole 216. Accordingly, the second fire-resistant assembly 270b may be exposed to the outside through the through-hole 216.

And the heat blocking member 119 may be disposed between the plurality of through-holes 216.

FIG. 5 illustrates a movement direction of gas during thermal runaway. As described above, due to the height of the second fire-resistant assembly 270b, an empty space is generated, and gas generated during thermal runaway may be rapidly discharged through the empty space, thereby delaying or preventing thermal propagation between the battery cells 110.

On the other hand, the heat blocking member 119 may block flame propagation between the battery groups BG, thereby allowing rapid discharge through the through-hole 216 adjacent to the battery cell 110 in which thermal runaway occurs.

The above description is merely an example applying the principle of the present disclosure, and other configurations may be further included without departing from the scope of the present invention.

What is claimed is:

1. A battery assembly comprising:
a plurality of battery cells stacked in a stacking direction;
a receiving case that receives the plurality of battery cells;
an insertion space formed between the plurality of battery cells and the receiving case;
a first fire-resistant assembly disposed in the insertion space; and
a second fire-resistant assembly having a height smaller than a height of the first fire-resistant assembly along a height direction of the receiving case.

2. The battery assembly according to claim 1, wherein the first fire-resistant assembly and the second fire-resistant assembly are arranged along the stacking direction.

3. The battery assembly according to claim 2, further comprising a heat blocking member disposed between the plurality of battery cells along the stacking direction.

4. The battery assembly according to claim 3, wherein the plurality of battery cells include a plurality of battery groups in which battery cells adjacent to each other are grouped by a predetermined number, and the heat blocking member is disposed between the plurality of battery groups.

5. The battery assembly according to claim 4, wherein the insertion space is partitioned by the heat blocking member.

6. The battery assembly according to claim 4, wherein the insertion space is partitioned by the heat blocking member, and the insertion space respectively receives the first fire-resistant assembly and the second fire-resistant assembly.

7. The battery assembly according to claim 2, further comprising a through-hole that is formed by penetrating one surface of the receiving case along the stacking direction and overlaps the insertion space.

8. The battery assembly according to claim 7, wherein the plurality of battery cells include a plurality of battery groups in which battery cells adjacent to each other are grouped by a predetermined number, and the through-hole is provided as a plurality of through-holes, and the plurality of through-holes are disposed to overlap the plurality of battery groups.

9. The battery assembly according to claim 8, further comprising a heat blocking member disposed between the plurality of battery groups along the stacking direction.

10. The battery assembly according to claim 8, wherein the first fire-resistant assembly and the second fire-resistant assembly are respectively provided as a plurality, and at least some of the plurality of second fire-resistant assemblies are disposed to overlap the plurality of through-holes.

11. The battery assembly according to claim 1, wherein the first fire-resistant assembly and the second fire-resistant assembly respectively include a fire-resistant member that includes a fire-resistant material; and an outer member that forms a fire-resistant space receiving the fire-resistant member therein, and a height of the outer member of the first fire-resistant assembly is greater than a height of the outer member of the second fire-resistant assembly.

12. The battery assembly according to claim 1, wherein each of the plurality of battery cells includes a body portion that receives an electrode assembly therein; and a lead tab portion that is electrically connected to the electrode assembly and protrudes from the body portion, and the insertion space is partitioned into a plurality of separated spaces by the respective lead tab portions of the plurality of battery cells.

13. The battery assembly according to claim 12, wherein the first fire-resistant assembly is received in any one of the plurality of separated spaces, and the second fire-resistant assembly is received in another one of the plurality of separated spaces.

14. The battery assembly according to claim 1, wherein the insertion space includes a first insertion space and a second insertion space that are formed with the plurality of battery cells therebetween, and the first fire-resistant assembly and the second fire-resistant assembly are disposed in at least any one of the first insertion space and the second insertion space.

15. A battery assembly comprising:
a plurality of battery cells stacked in a stacking direction;
a receiving case that receives the plurality of battery cells;
a busbar that is electrically connected to the plurality of battery cells inside the receiving case;
an insertion space formed between the plurality of battery cells and the busbar;
a first fire-resistant assembly disposed in the insertion space; and
a second fire-resistant assembly having a height smaller than a height of the first fire-resistant assembly along a height direction of the receiving case.
